(19) United States
(12) Patent Application Publication
(10) Pub. No.: US 2017/0082129 A1
(43) Pub. Date: Mar. 23, 2017

(54) LIQUID-RESISTANT SEALING FASTENER ASSEMBLY

(71) Applicant: ILLINOIS TOOL WORKS INC., Glenview, IL (US)

(72) Inventor: Mark O. LEPPER, Oak Park, IL (US)

(21) Appl. No.: 15/308,411

(22) PCT Filed: Mar. 26, 2015
(86) PCT No.: PCT/US2015/022800

§ 371 Date: Nov. 2, 2016

Related U.S. Application Data
(60) Provisional application No. 61/991,653, filed on May 12, 2014.

(51) Int. Cl. F16B 21/08; F16B 5/06

(52) U.S. Cl. CPC F16B 21/086; F16B 5/065

(57) ABSTRACT

A sealing fastener assembly includes a main body configured to securely connect to at least one component, and at least one hydrophobic member coupled to the main body. The hydrophobic member(s) is configured to prevent liquid from infiltrating into and through the main body.

### RELATED APPLICATIONS

This application relates to and claims priority benefits from U.S. Provisional Patent Application No. 61/991,653 entitled “Hydrophobic Sealing Fastener Assembly,” filed May 12, 2014, which is hereby incorporated by reference in its entirety.

### FIELD OF EMBODIMENTS OF THE DISCLOSURE

Embodiments of the present disclosure generally relate to a sealing fastener assembly, and, more particularly, to a liquid-resistant sealing fastener assembly having one or more hydrophobic surfaces.

### BACKGROUND

Various fasteners are used to secure components together. For example, a clip fastener may be integrally molded and formed from a single piece of material, such as injection-molded plastic. The clip assembly may be used to connect one component, such as a panel, to another component, such as another panel, frame, device, or the like.

Known fastener assemblies exhibit little or no ability to provide a water-resistant seal. In order to prevent water infiltration through a typical fastener assembly, a separate and distinct foam gasket may be secured to a portion of the fastener assembly in order to provide a water-resistant seal. Another known fastener assembly includes a separate and distinct over-molded gasket that is formed over a portion of the fastener assembly in order to provide a sealing member.

Notably, in order to provide a sealing interface, member, or the like, a separate and distinct foam or over-molded gasket is typically secured to and/or formed on a fastener assembly, thereby adding time and cost to a manufacturing process.

### SUMMARY OF EMBODIMENTS OF THE DISCLOSURE

Certain embodiments of the present disclosure provide a sealing fastener assembly that may include a main body configured to securely connect to at least one component (such as a panel), and at least one hydrophobic member coupled to the main body. The hydrophobic member(s) is configured to prevent liquid from infiltrating into and through the main body.

The hydrophobic member(s) may include at least one hydrophobic coating that covers at least a portion of an outer surface of the main body. In at least one embodiment, the hydrophobic coating lines internal surfaces that define an internal chamber of a mold. The main body is formed by material deposited into the internal chamber. The hydrophobic coating adheres to the main body within the internal chamber.

In at least one other embodiment, the hydrophobic member(s) is formed through a hydrophobic additive that is added to a material that forms the main body. In at least one other embodiment, the hydrophobic member(s) includes a textured hydrophobic pattern formed on one or more surfaces of the main body.

The hydrophobic member(s) may be formed from one or more of Manganese Oxide Polystyrene nano-composite, Zinc Oxide Polystyrene nano-composite, Precipitated Calcium Carbonate, Carbon nano-tube structures, or Silica nano-coating. The main body may be formed through injection-molding, for example.

The main body may include a first securing portion coupled to a second securing portion. The first securing portion may include an end cap connected to a collar through a neck. The second securing portion may include one or more deflectable members connected to a distal tip.

Certain embodiments of the present disclosure provide a method of forming a sealing fastener assembly. The method may include forming a main body of the sealing fastener assembly, and coupling at least one hydrophobic member to the main body. The hydrophobic member(s) is configured to prevent liquid from infiltrating into and through the main body.

Certain embodiments of the present disclosure provide a sealing fastener assembly that may include a main body configured to securely connect to at least one component, and first and second hydrophobic members coupled to the main body. The first and second hydrophobic members are configured to prevent liquid from infiltrating into and through the main body. The first hydrophobic member may include a hydrophobic coating that covers at least a portion of an outer surface of the main body. The second hydrophobic member may include a textured hydrophobic pattern formed on one or more surfaces of the main body.

### BRIEF DESCRIPTION OF SEVERAL IE OF THE DRAWINGS

FIG. 1 illustrates a perspective view of a sealing fastener assembly in relation to a panel having a round opening, according to an embodiment of the present disclosure.

FIG. 2 illustrates a front view of a hydrophobic member being applied to a sealing fastener assembly, according to an embodiment of the present disclosure.

FIG. 3 illustrates a flow chart of a method of forming a sealing fastener assembly having a hydrophobic member, according to an embodiment of the present disclosure.

FIG. 4 illustrates a simplified internal view of a mold configured to form a sealing fastener assembly, according to an embodiment of the present disclosure.

FIG. 5 illustrates a flow chart of a method of forming a sealing fastener assembly having a hydrophobic member, according to an embodiment of the present disclosure.

FIG. 6 illustrates a simplified internal view of a mold configured to form a sealing fastener assembly, according to an embodiment of the present disclosure.

FIG. 7 illustrates a flow chart of a method of forming a sealing fastener assembly having a hydrophobic member, according to an embodiment of the present disclosure.

FIG. 8 illustrates a magnified view of a textured surface of a mold, according to an embodiment of the present disclosure.

FIG. 9 illustrates a magnified view of a textured surface of a mold, according to an embodiment of the present disclosure.

Before the embodiments of the disclosure are explained in detail, it is to be understood that the disclosure is not limited in its application to the details of construction and the arrangement of the components set forth in the following description or illustrated in the drawings. The disclosure is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF EMBODIMENTS OF THE DISCLOSURE

Embodiments of the present disclosure provide a liquid-resistant sealing fastener assembly including one or more hydrophobic (as used herein, the term “hydrophobic” includes both hydrophobic and super-hydrophobic) members, such as one or more coating(s), layer(s), surface(s), application(s), an integral body, and/or the like. In contrast to known fasteners, a separate and distinct foam or over-molded gasket is not necessary. Instead, the hydrophobic member that may cover at least a portion of the sealing fastener assembly provides a water-resistant layer that seals the sealing fastener assembly and prevents liquid from passing therethrough.

In at least one embodiment, the hydrophobic member may be or include a hydrophobic coating that may be directly applied to a sealing fastener assembly. For example, a sealing fastener assembly may be formed, and then a hydrophobic coating may be applied to a main body after the molding process. The application may be one or more of a hydrophobic spray, drip, vapor, liquid cascade, and/or the like.

In at least one other embodiment, the hydrophobic member may be or include a hydrophobic coating that may be applied to a sealing fastener assembly through a mold. For example, a mold may be used to form the sealing fastener assembly. A hydrophobic coating may be applied to an interior of the mold. As the material that forms the fastener assembly is inserted into the mold (such as through an injection molding process), the hydrophobic coating adheres to surfaces of the sealing fastener assembly. The material used to form the sealing fastener assembly, such as injection-molded plastic, may mold up against the hydrophobic coating within the mold.

In at least one other embodiment, the hydrophobic member may be formed by a hydrophobic texture that may be applied to a sealing fastener assembly. For example, a hydrophobic-imparting texture may be formed in the mold and adheres to, creates, or forms a surface of the fastener assembly during or after the molding process. A nano-size texture may be added to tooling, molding, or the like, for example. The material of the mold that is used to form the sealing fastener assembly may be etched, for example, with a nano-texture that may repel water (hydrophobic). The repelling texture is then applied to the fastener assembly through the mold.

In at least one other embodiment, the hydrophobic member may be formed through a hydrophobic additive that may be included in the material that forms the sealing fastener assembly. For example, a hydrophobic additive may migrate to surfaces of the sealing fastener assembly during and after molding. For example, a hydrophobic mold release may be used that leeches to surfaces, such as outer surfaces, of the fastener assembly during the molding process.

Embodiments of the present disclosure provide fastener assemblies that exhibit sealing properties without the use of additional components, such as gaskets or over-molded portions. Embodiments of the present disclosure provide sealing fastener assemblies that do not need a second tool or a complicated over-molding operation to form. Further, embodiments provide sealing fastener assemblies that minimize water absorption tendencies.

It has been found that sealing fastener assemblies according to embodiments of the present disclosure prevent, minimize, or otherwise reduce liquid infiltration therethrough. Through testing, it has been found that sealing fastener assemblies including one or more hydrophobic members according to embodiments of the present disclosure provide liquid-resistant barriers.

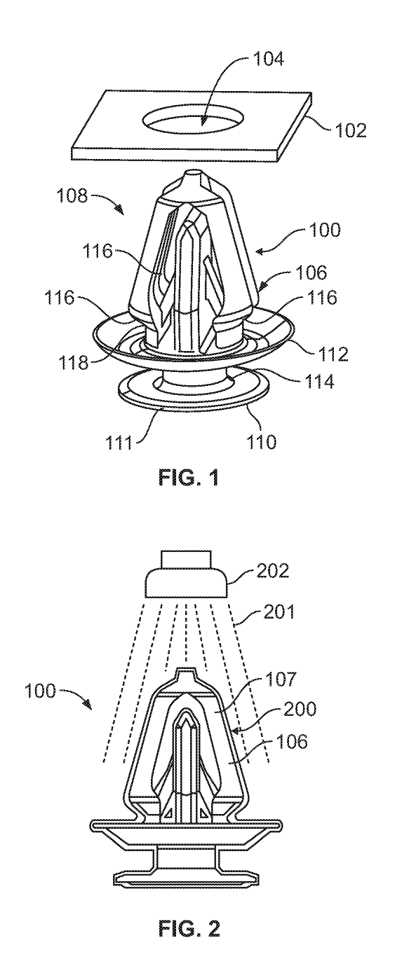

FIG. 1 illustrates a perspective view of a sealing fastener assembly 100 in relation to a panel 102 having a round opening 104, according to an embodiment of the present disclosure. The sealing fastener assembly 100 includes a main body 106 having a first securing portion 108 and a second securing portion 110. The main body 106 is configured to securely connect to one or more components, such as the panel 102.

The first securing portion 108 may include an end cap 111 connected to a collar 112 through a neck 114. A component, such as a different panel, may include an opening that is configured to secure around the neck 114 and be sandwiched between the end cap 111 and the collar 112.

The second securing portion 110 may include one or more deflectable members 116 that connect to a distal tip 118. The deflectable members 116 may be arms, legs, wings, or the like that are configured to inwardly deflect as they pass into the opening 104, and deflect outwardly after passing through, such that proximal surfaces that are collectively wider than the opening 104 abut into an upper surface of the panel 102 around the opening 104.

The main body 106 may include various other shapes and sizes than shown. For example, instead of the first and second securing portions 108 and 110, the main body 106 may include two securing portions that mirror one another. As another example, the main body 106 may include only one of the first and securing portions 108 or 110. Further, the main body 106 may include more or less deflectable members than shown. Also, alternatively, the main body 106 may include a W-shaped fastening interface, a rotary-style fastening interface, and/or the like.

The main body 106 may be integrally molded and formed through various processes. For example, the main body 106 may be integrally molded and formed as a single piece of injection molded plastic. After the main body 106 is formed, a hydrophobic member may be applied over at least a portion of the main body to provide a liquid-resistant seal.

FIG. 2 illustrates a front view of a hydrophobic member 200 being applied to the sealing fastener assembly 100, according to an embodiment of the present disclosure. The hydrophobic member 200 may be or include a hydrophobic coating that may be directly applied to the main body 106 of the sealing fastener assembly 100. As noted, the main body 106 may first be molded, and then the hydrophobic member 200 may be applied to the main body 106. As shown, a hydrophobic fluid 201 (such as a liquid, gel, slurry, or the like) may be emitted from a nozzle 202 and may coat outer surfaces 107 of the main body 106. Optionally, portions of the main body 106 may be covered with a masking agent to prevent the hydrophobic fluid 201 from securing thereon. As the hydrophobic fluid 201 cools, dries, cures, or the like, it securely adheres to the outer surfaces 107 of the main body 106 forming the hydrophobic member 200. As such, the hydrophobic member 200 provides an outer surface of the sealing fastener assembly 100 that repels liquid and prevents liquid from infiltrating into and through the sealing fastener assembly 100. The hydrophobic fluid 201 showers the main body 106 from the nozzle and provides an application that forms the hydrophobic member 200. While shown as a shower, the hydrophobic fluid 201 may be deposited on the main body 106 through various methods, such as a hydrophobic spray, drip, vapor, liquid cascade, and/or the like.

Embodiments of the present application provide hydrophobic members that may be or otherwise provide at least one nanoscopic surface layer that repels water. Each hydrophobic member described in the present application may be formed from one or more materials, such as Manganese Oxide Polystyrene nano-composite, Zinc Oxide

Polystyrene nano-composite, Precipitated Calcium Carbonate, Carbon nano-tube structures, Silica nano-coating, and/or the like. It is to be understood that various other materials other than those listed may be used to form the hydrophobic member

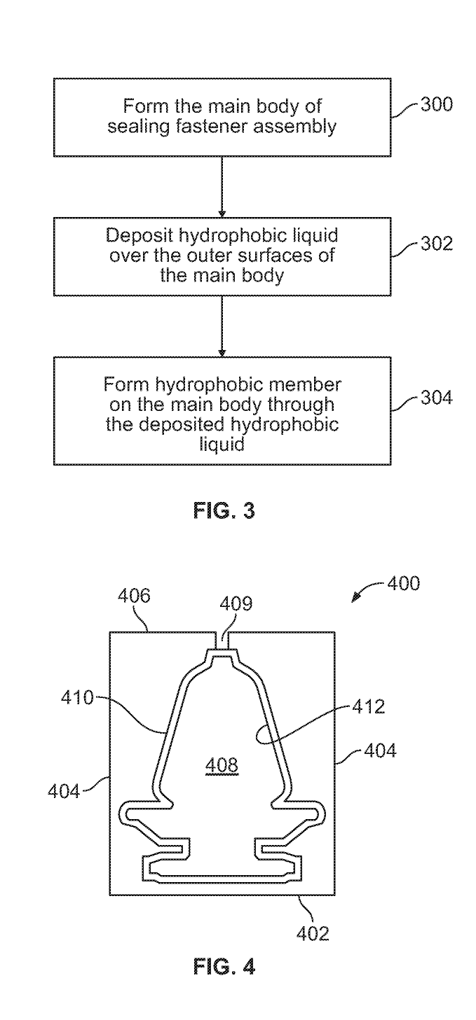

FIG. 3 illustrates a flow chart of a method of forming a sealing fastening clip assembly having a hydrophobic member, according to an embodiment of the present disclosure. At 300, a main body of a sealing fastener assembly is formed. The main body may be formed having various shapes, sizes, one or more securing portions and interfaces, and/or the like. The main body may be formed through a molding process. For example, the main body may be formed as an integrally molded and formed piece of injection-molded plastic. Alternatively, the main body may be formed from multiple pieces that are secured together, such as through bonding, adhesives, and/or the like.

After the main body of the sealing fastener assembly is formed, a hydrophobic liquid is deposited over one or more outer surfaces of the main body at 302. For example, the main body may be showered by a hydrophobic fluid. Optionally, the maim body may be dipped in a bath of hydrophobic fluid. After the hydrophobic fluid is applied to the outer surface(s) of the main body at a desired thickness, the hydrophobic fluid is allowed to securely adhere to the outer surface(s) of the main body, such as through cooling and hardening. At 304, a hydrophobic member is formed on the main body through the deposited hydrophobic fluid.

FIG. 4 illustrates a simplified internal view of a mold 400 configured to form a sealing fastener assembly, according to an embodiment of the present disclosure. The mold 400 includes a base 402 connected to upstanding walls 404 and an upper surface 406 that define an internal fastener forming chamber 408. A channel 409 extends through the upper surface 406 into the fastener forming chamber 408. Internal surfaces 410 that define the fastener forming chamber 408 define a shape of a sealing fastener assembly to be formed.

Before injecting a plastic into the fastener forming chamber 408 that is to form a main body of the fastener assembly, a hydrophobic coating 412 is used to coat the internal surface 410. The hydrophobic coating 412 may coat all of the internal surface 410. Alternatively, the hydrophobic coating 412 may be applied to less than all of the internal surface 410. After the hydrophobic coating 412 adheres to the internal surface 410, plastic may be injected into the fastener forming chamber 408 to form the main body of the fastener assembly. As the plastic contacts the hydrophobic coating 412, the hydrophobic coating 412 adheres to, creates, or forms the plastic as it cools and hardens, thereby forming the hydrophobic member on the main body of the sealing fastener assembly.

As described, the hydrophobic member may be or include a hydrophobic coating that may be applied to a sealing fastener assembly through a mold. The mold may be used to form the sealing fastener assembly. A hydrophobic coating may be applied to an interior of the mold, such as described with respect to FIG. 4. As the material that forms the fastener assembly is inserted into the mold (such as through an injection molding process), the hydrophobic coating adheres to surfaces of the sealing fastener assembly. The material used to form the sealing fastener assembly, such as injection-molded plastic, may mold up against the hydrophobic coating within the mold.

Alternatively, instead of applying the hydrophobic coating 412, the hydrophobic member may be formed through a hydrophobic additive that may be included in the material that forms the sealing fastener assembly. For example, a hydrophobic additive may migrate to surfaces of the sealing fastener assembly during and after molding. In at least one embodiment, a hydrophobic mold release may be used that leeches to surfaces, such as outer surfaces, of the sealing fastener assembly during the molding process. Thus, the material that forms the sealing fastener assembly may include a first material to form the main body (such as plastic), and a second material to form the hydrophobic member, which may migrate to outer surfaces of the sealing fastener assembly during and/or after the molding process.

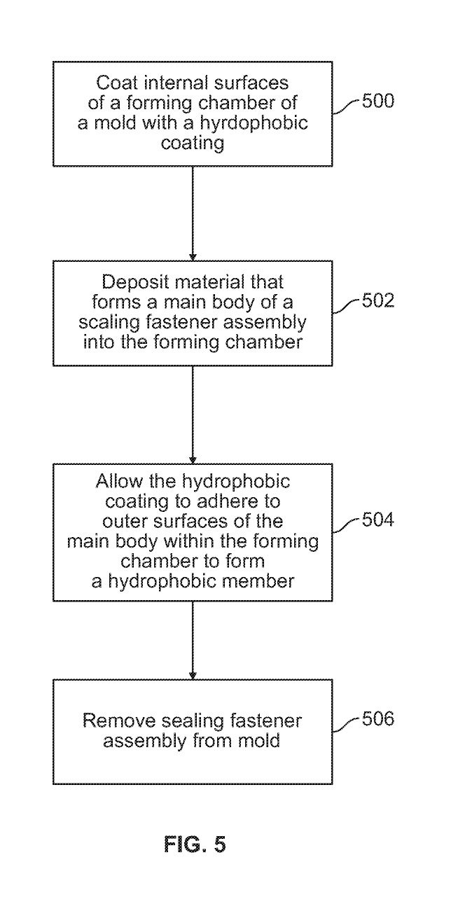

FIG. 5 illustrates a flow chart of a method of forming a sealing fastener assembly having a hydrophobic member, according to an embodiment of the present disclosure. At 500, internal surfaces of a forming chamber of a mold are coated with a hydrophobic coating. After the internal surfaces are coated, material that forms a main body of a sealing fastener assembly is deposited into the forming chamber at 502. As the material is deposited into the forming chamber (such as by being injected into the forming chamber), the hydrophobic coating adheres to the material. At 504, the hydrophobic coating is allowed to adhere to outer surfaces of the main body within the forming chamber to form a hydrophobic member. The sealing fastener assembly is then allowed to fully form, such as through cooling and hardening. Then, at 506, the sealing fastener assembly is removed from the mold.

While described as an injection-molding process, the main body may be formed through various other processes and molds. A hydrophobic coating may be applied to internal surfaces of the mold that define a shape of the sealing fastener assembly. As the material that forms the main body is positioned within the mold, the hydrophobic coating may adhere to the material to form the hydrophobic member.

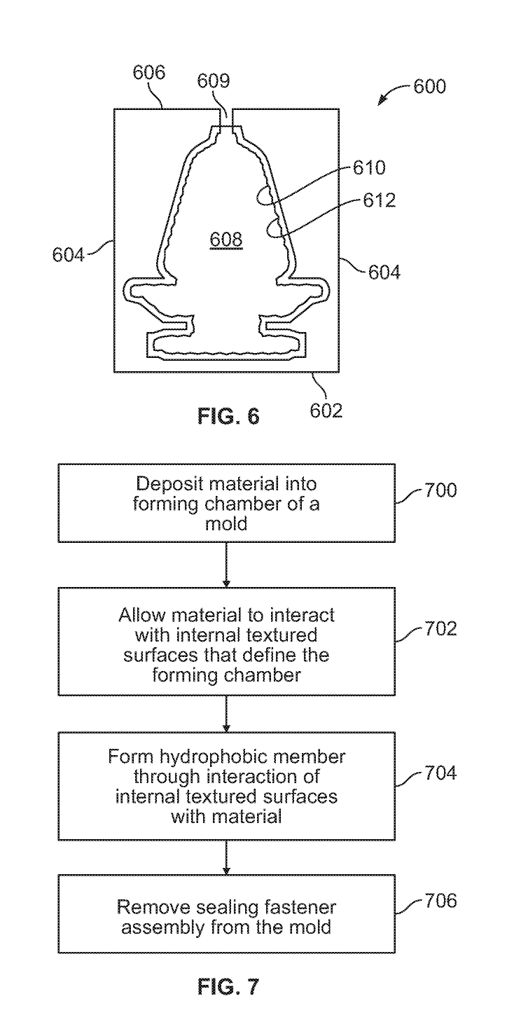

FIG. 6 illustrates a simplified internal view of a mold 600 configured to form a sealing fastener assembly, according to an embodiment of the present disclosure. The mold 600 includes a base 602 connected to upstanding walls 604 and an upper surface 606 that define an internal fastener forming chamber 608. A channel 609 extends through the upper surface 606 into the fastener forming chamber 608. Internal surfaces 610 that define the fastener forming chamber 608 define a shape of a sealing fastener assembly to be formed.

The internal surfaces 610 include a textured interface 612. As the material that forms the main body of the sealing fastener assembly is deposited into the forming chamber 608, the textured interface 612 imparts a corresponding texture into an outer surface of the main body. The textured interface 612 is configured to impart a hydrophobic (liquid-repelling) outer texture to the main body. Accordingly, the texture interface 612 forms a hydrophobic member on surfaces of the main body of the sealing fastener assembly. In such an embodiment, a separate and distinct hydrophobic coating is not necessary. Alternatively, however, a separate and distinct hydrophobic coating may also be used.

The hydrophobic member may be formed by the hydrophobic textured interface 612. The textured interface 612 may be a nano-size texture that may be added to tooling, molding, or the like. In at least one embodiment, the textured interface 612 is integrally formed with the mold 600. For example, the material (such as steel) of the mold 600 may be etched, for example, with a nano-texture that may repel water. The repelling textured interface 612 is then applied to the fastener assembly through the mold 600.

FIG. 7 illustrates a flow chart of a method of forming a sealing fastener assembly having a hydrophobic member, according to an embodiment of the present disclosure. At 700, material is deposited into a forming chamber of a mold. For example, liquid plastic may be injected into the forming chamber. At 702, the material interacts with one or more internal textured surfaces that define the forming chamber. For example, the internal textured surfaces may be nano-sized textured surfaces that define a hydrophobic surface. At 704, a hydrophobic member is formed through interaction of the internal textured surface(s) with the material. At 706, the sealing fastener assembly is removed from the mold.

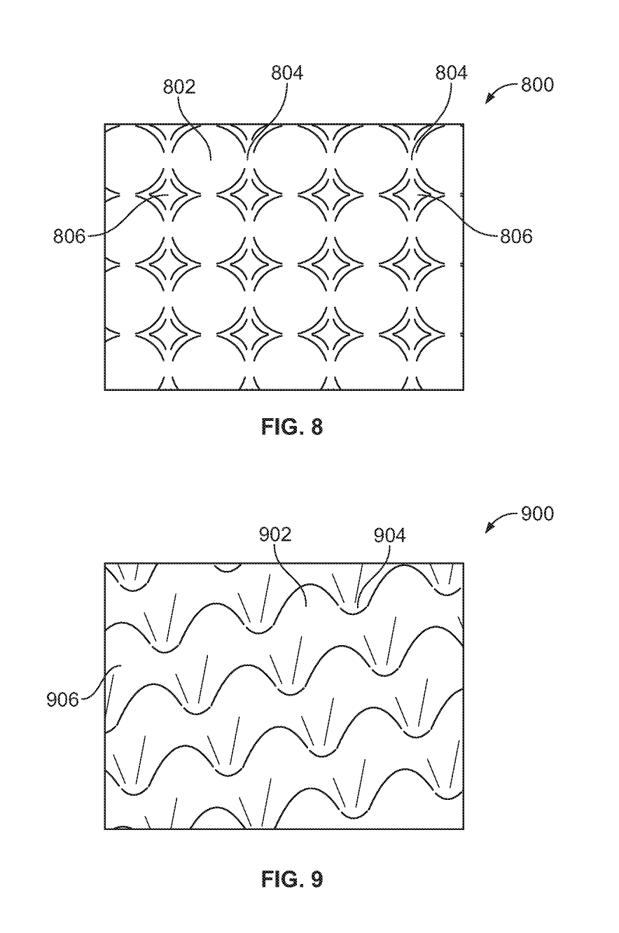

FIG. 8 illustrates a magnified view of a textured surface 800 of a mold, according to an embodiment of the present disclosure. The textured surface 800 may be a nano-sized surface that is configured to impart a hydrophobic member into and/or onto a surface of a main body of the sealing fastener assembly. The textured surface 800 may include a regular pattern of protuberances 802, such as hemispherical bumps, connected to one another through recessed portions 804. Additionally, gaps 806 may be defined between adjacent protuberances 802. The textured surface 800 imparts an inverse pattern into an outer surface of the main body. The inverse pattern is configured to repel liquid.

FIG. 9 illustrates a magnified view of a textured surface of a mold, according to an embodiment of the present disclosure. The textured surface 900 may be a nano-sized surface that is configured to impart a hydrophobic member into and/or onto a surface of a main body of the sealing fastener assembly. The textured surface 900 may include a regular pattern of peaks 902, such as hemispherical tooth-shaped ridges, connected to one another through valleys 904. Additionally, gaps 906 may be defined between adjacent rows of peaks 902. The textured surface 900 imparts an inverse pattern into an outer surface of the main body. The inverse pattern is configured to repel liquid.

Referring to FIGS. 8 and 9, the textured surfaces may be nano-sized textures that impart a corresponding hydrophobic texture into and/or onto a surface of a sealing fastener assembly. The resulting hydrophobic textures may be similar or the same as the surface of a Lotus leaf, which is naturally hydrophobic (for example, the Lotus effect).

Referring to FIGS. 1-9, any of the embodiments may be used by themselves, or in conjunction with other embodiments. For example, a sealing fastener assembly may be formed through a mold having hydrophobic textured surfaces that define an internal chamber. The sealing fastener assembly may be removed from the mold, and then a separate and distinct hydrophobic member may be deposited over one or more surfaces of the sealing fastener assembly.

Embodiments of the present disclosure may be used with various types of sealing fastener assemblies other than those shown and described. For example, hydrophobic members may be used with fastener assemblies such as described in U.S. Pat. No. 6,796,006, entitled “Rib Clip,” U.S. Pat. No. 6,974,292, entitled “One-Piece Reusable Plastic Fastener,” and U.S. Pat. No. 8,613,128, entitled “Push-In Fastener Assembly,” all of which are hereby incorporated by reference in their entireties.

As described above, embodiments of the present disclosure provide sealing fastener assemblies that exhibit sealing properties without the use of additional components, such as gaskets or over-molded components. Embodiments of the present disclosure provide sealing fastener assemblies that may not need a second tool or a complicated over-molding operation to form. Further, embodiments provide sealing fastener assemblies that minimize or otherwise reduce water absorption tendencies.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

Variations and modifications of the foregoing are within the scope of the present disclosure. It is understood that the embodiments disclosed and defined herein extend to all alternative combinations of two or more of the individual features mentioned or evident from the text and/or drawings. All of these different combinations constitute various alternative aspects of the present disclosure. The embodiments described herein explain the best modes known for practicing the disclosure and will enable others skilled in the art to utilize the disclosure. The claims are to be construed to include alternative embodiments to the extent permitted by the prior art.

To the extent used in the appended claims, the terms “including” and “in which” are used as the plain-English equivalents of the respective terms “comprising” and “wherein.” Moreover, to the extent used in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure.

Various features of the disclosure are set forth in the following claims.

1. A sealing fastener assembly, comprising:
a main body configured to securely connect to at least one component; and
at least one hydrophobic member coupled to the main body, wherein the at least one hydrophobic member is configured to prevent liquid from infiltrating into and through the main body.

2. The sealing fastener assembly of claim 1, wherein the at least one hydrophobic member comprises at least one hydrophobic coating that covers at least a portion of an outer surface of the main body.

3. The sealing fastener assembly of claim 1, wherein the at least one hydrophobic member comprises a hydrophobic coating that lines internal surfaces that define an internal chamber of a mold, wherein the main body is formed by material deposited into the internal chamber, and wherein the hydrophobic coating adheres to the main body within the internal chamber.

4. The sealing fastener assembly of claim 1, wherein the at least one hydrophobic member is formed through a hydrophobic additive that is added to a material that forms the main body.

5. The sealing fastener assembly of claim 1, wherein the at least one hydrophobic member comprises a textured hydrophobic pattern formed on one or more surfaces of the main body.

6. The sealing fastener assembly of claim 1, wherein the at least one hydrophobic member is formed from one or more of Manganese Oxide Polystyrene nano-composite, Zinc Oxide Polystyrene nano-composite, Precipitated Calcium Carbonate, Carbon nano-tube structures, or Silica nano-coating.

7. The sealing fastener assembly of claim 1, wherein the main body is formed through injection-molding.

8. The sealing fastener assembly of claim 1, wherein the main body comprises a first securing portion coupled to a second securing portion, wherein the first securing portion comprises an end cap connected to a collar through a neck, and wherein the second securing portion comprises one or more deflectable members connected to a distal tip.

9. A method of forming a sealing fastener assembly, comprising:
forming a main body of the sealing fastener assembly; and
coupling at least one hydrophobic member to the main body, wherein the at least one hydrophobic member is configured to prevent liquid from infiltrating into and through the main body.

10. The method of claim 9, wherein the coupling operation comprises covering at least a portion of an outer surface of the main body with a hydrophobic coating.

11. The method of claim 9, wherein the coupling operation comprises:
lining internal surfaces that define an internal chamber of a mold with a hydrophobic coating, wherein the forming the main body operation comprises depositing material that forms the main body into the internal chamber after the lining operation; and
adhering the hydrophobic coating to the main body within the internal chamber.

12. The method of claim 9, wherein the coupling operation comprises adding a hydrophobic additive to a material that forms the main body.

13. The method of claim 9, wherein the coupling operation comprises forming at least one textured hydrophobic pattern on one or more surfaces of the main body.

14. The method of claim 9, wherein the at least one hydrophobic member is formed from one or more of Manganese Oxide Polystyrene nano-composite, Zinc Oxide Polystyrene nano-composite, Precipitated Calcium Carbonate, Carbon nano-tube structures, or Silica nano-coating.

15. The method of claim 9, wherein the forming the main body operation comprises injecting fluid plastic into forming chamber of a mold.

16. The method of claim 9, wherein the forming the main body operation comprises coupling a first securing portion to a second securing portion, wherein the first securing portion comprises an end cap connected to a collar through a neck, and wherein the second securing portion comprises one or more deflectable members connected to a distal tip.

17. A sealing fastener assembly, comprising:
a main body configured to securely connect to at least one component;
a first hydrophobic member coupled to the main body, wherein the first hydrophobic member is configured to prevent liquid from infiltrating into and through the main body, wherein the first hydrophobic member comprises a hydrophobic coating that covers at least a portion of an outer surface of the main body; and
a second hydrophobic member coupled to the main body, wherein the second hydrophobic member is configured to prevent liquid from infiltrating into and through the main body, wherein the second hydrophobic member comprises a textured hydrophobic pattern formed on one or more surfaces of the main body.

18. The sealing fastener assembly of claim 17, wherein the hydrophobic coating is coupled to the main body by lining internal surfaces that define an internal chamber of a mold with the hydrophobic coating, wherein the main body is formed by material deposited into the internal chamber, and wherein the hydrophobic coating adheres to the main body within the internal chamber.

19. The sealing fastener assembly of claim 17, wherein the at least one hydrophobic member is formed from one or more of Manganese Oxide Polystyrene nano-composite, Zinc Oxide Polystyrene nano-composite, Precipitated Calcium Carbonate, Carbon nano-tube structures, or Silica nano-coating.

20. The sealing fastener assembly of claim 1, wherein the main body comprises a first securing portion coupled to a second securing portion, wherein the first securing portion comprises an end cap connected to a collar through a neck, and wherein the second securing portion comprises one or more deflectable members connected to a distal tip.
